(19) United States
(12) Patent Application Publication
(10) Pub. No.: US 2015/0032499 A1
(43) Pub. Date: Jan. 29, 2015

(54) BUSINESS PROCESS EVENT MAPPING

(71) Applicant: INTERNATIONAL BUSINESS MACHINES CORPORATION, Armonk, NY (US)

(72) Inventors: Matthew J. Duftler, Mahopac, NY (US); Amos A. Omokpo, Bronx, NY (US); Aubrey J. Rembert, Tarrytown, NY (US); Szabolcs Rozsnyai, New York, NY (US)

(73) Assignee: INTERNATIONAL BUSINESS MACHINES CORPORATION, Armonk, NY (US)

(21) Appl. No.: 13/948,954

(22) Filed: Jul. 23, 2013

(51) Int. Cl. G06Q 10/06

(52) U.S. Cl. CPC G06Q 10/0633
USPC 705/7.27

(57) ABSTRACT

Methods and systems for mapping an event type to an activity in a business process model are disclosed. In accordance with one such method, the event type and the activity are tokenized by determining event tokens for event type labels in the event type and determining activity tokens for activity labels in the activity. In addition, a score matrix is generated for pairs of the event tokens and the activity tokens indicating a degree of similarity between the event token and the activity token in each of the pairs. The method also includes determining whether the event type and the activity are correlated by determining scores of the pairs of event tokens and activity tokens that are ranked highest in said score matrix. Further, a mapping report indicating whether the event type and the activity are correlated in the business process model is output.

### BACKGROUND

1. Technical Field

The present invention relates to business process models, and more particularly to mapping of items in business process models.

2. Description of the Related Art

Business process models generally are designed to have a certain level of detail to permit users to make qualitative assessments about the state of a business enterprise. However, business process models are not necessarily complete or correct and are often simplified. There are several reasons for these characteristics of business process models. For example, business processes are typically not understood sufficiently to design a complete model. Gaining the knowledge needed to model a detailed and accurate view is a very resource and time consuming task. Further, a simplified version of the process model is oftentimes sufficient for purposes of providing an overview. In addition, because the activities can be complex (e.g. exceptions) and entail a substantial amount of individual knowledge, it is very difficult to model them without sacrificing a certain degree of freedom.

Processes that are heavily human-driven entail a significant amount of knowledge, as they have a large number of exceptions. Thus, they are modeled in a simplified way to preserve a high degree of freedom. Information about how a process is conducted is in the minds of individuals, groups or, if activities are (semi) automated, are buried in application logic. Extracting this type of knowledge is a time consuming and resource intensive task. In addition business processes and systems supporting them change over time, which in turn would entail re-discovering the process models from the corresponding entities.

### SUMMARY

One exemplary embodiment of the present invention is directed to a method for mapping an event type to an activity in a business process model. In accordance with the method, the event type and the activity are tokenized by determining event tokens for event type labels in the event type and determining activity tokens for activity labels in the activity. In addition, a score matrix is generated for pairs of the event tokens and the activity tokens indicating a degree of similarity between the event token and the activity token in each of the pairs. The method also includes determining whether the event type and the activity are correlated by determining scores of the pairs of event tokens and activity tokens that are ranked highest in the score matrix. Further, a mapping report indicating whether the event type and the activity are correlated in the business process model is output.

Another exemplary embodiment is directed to a computer readable storage medium comprising a computer readable program for mapping an event type to an activity in a business process model, where the computer readable program when executed on a computer causes the computer to perform the steps of: tokenizing the event type and the activity by determining event tokens for event type labels in the event type and determining activity tokens for activity labels in the activity; generating a score matrix for pairs of the event tokens and the activity tokens indicating a degree of similarity between the event token and the activity token in each of the pairs; determining whether the event type and the activity are correlated by determining scores of the pairs of event tokens and activity tokens that are ranked highest in the score matrix; and outputting a mapping report indicating whether the event type and the activity are correlated in the business process model.

Another exemplary embodiment is directed to a system for mapping an event type to an activity in a business process model. The system includes a tokenizer, a token mapper and a similarity calculator. The tokenizer is configured to tokenize the event type and the activity by determining event tokens for event type labels in the event type and determining activity tokens for activity labels in the activity. In addition, the token mapper is configured to generate a score matrix for pairs of the event tokens and the activity tokens indicating a degree of similarity between the event token and the activity token in each of the pairs and is configured to perform at least one of an assessment of whether any of the event tokens and the activity tokens are natural language synonyms or a determination of a string edit distance between the event token and the activity token in each pair of at least a subset of the pairs. Further, the similarity calculator is configured to determine whether the event type and the activity are correlated by determining scores of the pairs of event tokens and activity tokens that are ranked highest in the score matrix and to output a mapping report indicating whether the event type and the activity are correlated in the business process model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a high-level block/flow diagram of a process mapping lifecycle 100 in accordance with an exemplary embodiment of the present invention;

FIGS. 2 and 3 are high-level block/flow diagrams illustrating the function of a mapping suggestor in accordance with an exemplary embodiment of the present invention;

FIG. 4 is a high-level block/flow diagram of a mapping suggestor system/method in accordance with an exemplary embodiment of the present invention;

FIG. 5 is a high-level block/flow diagram illustrating the function of a tokenizer in accordance with an exemplary embodiment of the present invention;

FIG. 6 is a high-level block/flow diagram illustrating the function of a token stemmer in accordance with an exemplary embodiment of the present invention;

FIG. 7 is a high-level block/flow diagram illustrating the function of a token mapper in accordance with an exemplary embodiment of the present invention;

FIG. 8 is a high-level flow diagram of a token mapping method in accordance with an exemplary embodiment of the present invention;

FIG. 9 is a high-level block/flow diagram illustrating the function of a similarity calculator in accordance with an exemplary embodiment of the present invention; and

FIG. 10 is a high-level block diagram of a computing system by which exemplary method and system embodiments of the present invention can be implemented.

### DETAILED DESCRIPTION OF PREFERRED EMBODIMENTS

Business process activities can be represented through multiple events. In addition, workflow engines can emit events to mark the start and end of an activity. At times, the modeled granularity of activities does not represent each step that is taken in practice, in the actual business process the model represents. As indicated above, mapping event types to activities entails the accumulation of a substantial amount of knowledge. If that knowledge were present or known, then the process model would have been designed to incorporate the knowledge and would be more detailed. Mapping event types to activities would preserve the connection from actual runtime events to business processes modeled at a coarse grain, thereby enabling several application use-cases. Automatically mapping between event types and activities in a modeled process presents a very difficult challenge.

Process models can be modeled using various tools following various modeling standards, such as, for example, Business Process Model and Notation (BPMN) and Event-driven Process Chain (EPC). Most of the systems that support business processes emit events ranging from record entries in databases to ESB messages. Each of those events can be collected, stored and uniquely named. Depending on the abstraction level of business process models, individual activities may be represented by several events. This is often the case in workflow engines that trigger, for example, start and end events for each activity. Another scenario is that the activities in the process model are not represented to a granularity that is sufficiently fine to reflect each step that is taken in in practice due to the several reasons noted above. The challenge of mapping event types to activities is that it entails acquiring knowledge across abstraction layers, e.g. of the intended business logic, and a determination of the link between the higher level activity and the particular system that generates events that correspond to this activity. Modeled processes in practice contain only an activity name and, in some mature cases, additional resource information such as departments or group identifiers (ids).

The preferred systems and methods described herein recieves a list of event types and process models, such as, for example BPMN models, as an input. The mapping component employs several text analytic techniques to suggest a mapping between event types and activities of a given process model. One activity might contain a mapping to multiple event types. The mapping component is capable of incorporating external semantic knowledge. For example, the mapping component can resolve that the number 051 is the identifier of the marketing department. The suggested mapping can be adjusted by a user.

The mapping described herein can be used in many different scenarios and can offer several benefits. For example, the mapping can improve explorative process analytics. Here, events can be correlated to isolate a specific process (i.e. create traces) that correspond to business process models. As event types are mapped to activities in that process model, a user would be able to use the process model as a reference point to analyze process executions. Queries could be used to constrain the resultant set, and by clicking on activities, the corresponding events can be retrieved or could be highlighted in the resultant set.

The mapping can improve process mining. For example, assume a large end-to-end process includes coarse grained activities and several event types are mapped on certain activities. Then, process mining techniques can be applied to permit understanding of how specific activities are conducted. This knowledge can then be used to detail the process model. Queries can be employed to segment data and improve understanding using a process model as a reference point.

Further, the mapping can improve process deviation detection. A process model can be viewed as the current reference point for purposes of understanding how a business process should be executed. Events mapped to activities deliver a model that can be monitored for deviations or groups of deviations. For example, new patterns of behavior might evolve and could be mined and analyzed. The mapping might reveal that some groups of new behavior could be new best practices that then can be incorporated into the process model. Otherwise, if the behavior is negative or detrimental to the business process in some way, then this can prompt the user to change the process or introduce policies that avoid this kind of behavior.

As will be appreciated by those skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

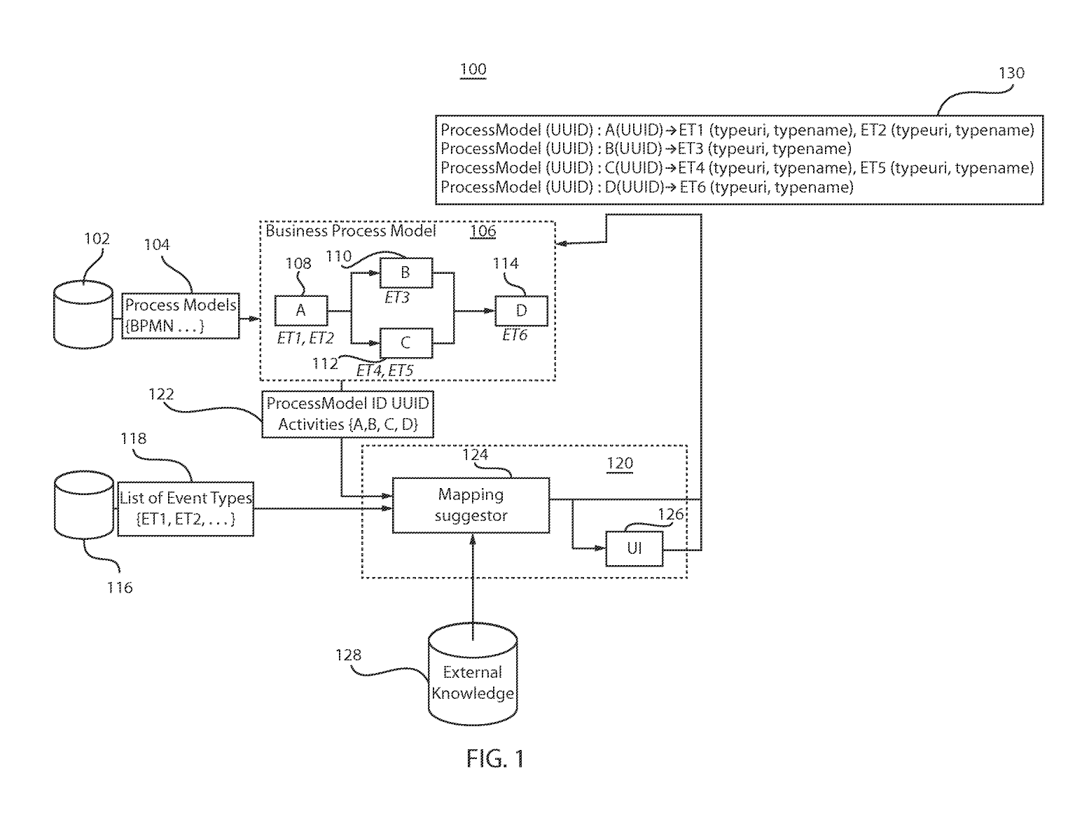

Referring now to the drawings in which like numerals represent the same or similar elements and initially to FIG. 1, an exemplary process mapping lifecycle 100 in accordance with preferred embodiments of the present invention is illustratively depicted. It should be noted that, for expository purposes, an “event,” “event type” and “activity,” as referenced with respect to the embodiments illustrated in the figures, has the same meaning applied to these terms in the BPMN 2.0 standard. However, it should be understood that equivalents to those terms, including, for example, those applied in, the EPC standards, as well as other equivalents to those terms, are encompassed by the preferred embodiments of the present invention.

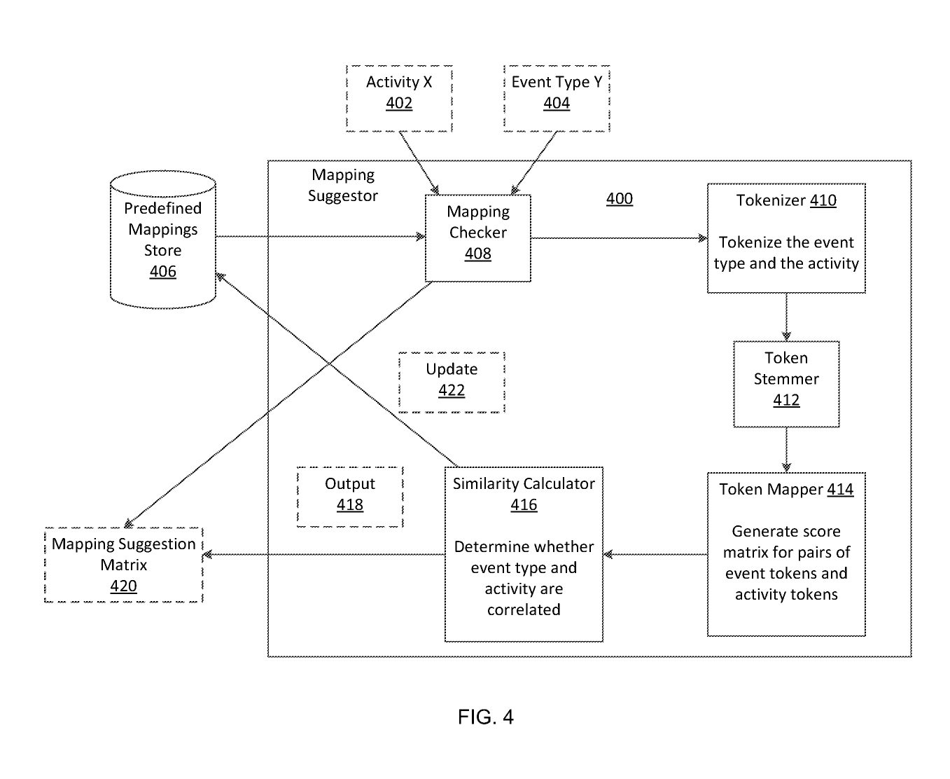

As illustrated in FIG. 1, a set of business process models, in accordance with various standards, including BPMN, can be retrieved from a store 102, such as a storage medium, and analyzed. Element 106 illustrates some details of an example of a business process model. Here, the business process model 106 includes activities A 108, B 110, C 112 and D 114. A process mapping system 120, an example of which is described in detail herein below with respect to FIG. 4, can retrieve or extract from the model 106 information 122 that can include the process model ID (identifier), which can be a universally unique identifier (UUID), as well as descriptions of activities. In addition, the process mapping system 120 can also retrieve a list 118 of event types ET1, ET2, . . . , from a store 116, such as a storage medium, and analyzed. Here, a mapping suggestor 124 in the process mapping element 120 can receive information 122 and information 118 as inputs, as well as external knowledge or information 128, and can output mappings 130 between activities in the business process model 106 and the events in the list 118. The external information 128 can also be retrieved from a store and enables the mapping suggestor 124 to incorporate semantic knowledge to make correlations between terms. For example, the information 128 may correlate “department 051” to “marketing” and permits the suggestor 124 to resolve the equivalency between these two terms. In addition, the process mapping system 120 can include a user interface 126 to permit a user to adjust the mapping suggestions if necessary. The mapping suggestor 124 can be configured to output mapping suggestions 130 which map or correlate activity A 108 to event types ET1 and ET2, activity B 110 to event type ET3, activity C 112 to event types ET4 and ET5 and activity D 114 to event type ET6. For example, as illustrated in FIG. 1, the activities can be identified by their own respective UUIDs and the event types can be identified by their own respective identifiers and semantic names.

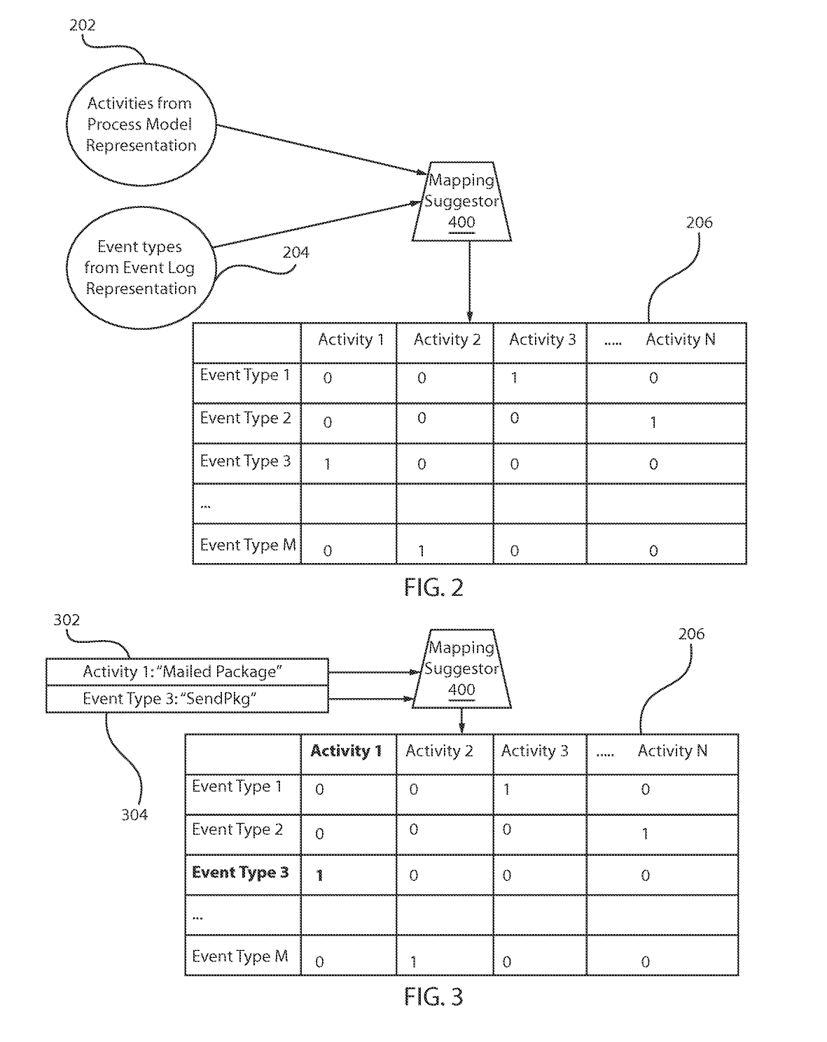

FIG. 2 provides an illustration of the function of a mapping suggestor 400, which is an example of the mapping suggestor 120. Here, the mapping suggestor 400 recives activities 202 from a process model representation and event types 204 from an event log representation and outputs an activity-event type mapping suggestion matrix 206 denoting Activities 1, 2, 3 . . . N and Event Types 1, 2, 3 . . . M. Each entry (Activity n, Event Type m) in this example is a 1 or a 0, where a 1 indicates that the Activity n and Event Type m are correlated or mapped, and a 0 can indicate that the Activity n and Event Type m are not correlated or that there is insufficient information to correlate or map Activity n and Event Type m.

For example, Activity 1 and Event Type 3 are discussed here for expository purposes. The process described herein can be applied to any (Activity n, Event Type m) pair and, preferably is applied to each (Activity n, Event Type m) pair. In one example, the activities can be mapped through text labels. For example, as illustrated in FIG. 3, information 202 can denote Activity 1 as the text “mail package” 302, while the information 204 can denote Event Type 3 as “SendPkg” 304. Here, the mapping suggestor 400 can receive text labels 302 and 304 and can employ them to correlate Activity 1 and Event Type 3.

With reference now to FIG. 4, a block/flow diagram of a more detailed illustration of the mapping suggestor system/method 400 is provided. For example, an Activity X 402 and an Event Type Y 404 can be input to the mapping suggestor 400 as discussed above. Here, an optional mapping checker 408 can review the Activity X and Event Type Y pair and can determine whether the pair exists in a pre-defined mapping store 406. The pre-defined mapping store 406 can include pre-defined mappings between event types and activities and can be updated through iterations of the method, as discussed herein below. Thus, if the mapping checker 408 determines that the Activity X and the Event Type Y are present in the mappings store 406, then the mapping checker 408 can immediately populate the Activity X and Event Type Y entry in the suggestion matrix 420 with a 1 and then evaluate the next (Activity n, Event Type m) pair. Otherwise, the method 400 can proceed to the Tokenizer Block 410.

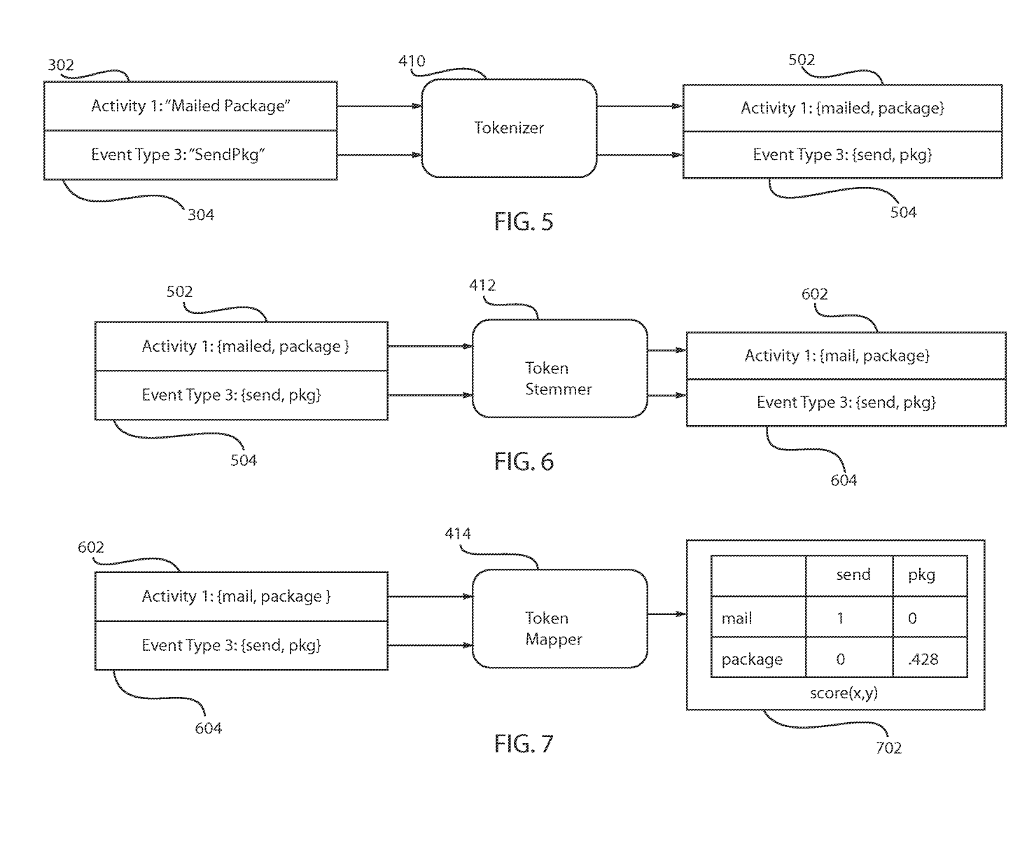

As illustrated in FIG. 5, the tokenizer 410 can tokenize the event type and the activity by determining event tokens for event type labels in the event type and determining activity tokens for activity labels in the activity. For example, the tokenizer 410 can split activity/event type labels into tokens using whitespace, dashes, underscores, CamelCase, etc. Here, the tokenizer 410 can split Activity text label “Mailed Package” 302 into tokens (mailed, package) 502 and can split the Event Type text label “SendPkg” 304 into tokens (send, pkg) 504. Of course, if the mapping checker 408 and the predefined mappings store 406 are employed, then the labels of the Activity-Event Type pairs are tokenized only if there is no predefined Activity-Event Type mapping in the pre-defined mapping data store 406.

Optionally, the system/method 400 can employ a token stemmer 412. For example, as illustrated in FIG. 6, the token stemmer 412 can stem the tokens to find root terms and alter the tokens appropriately. For example, the token stemmer 412 can stem activity tokens (mailed, package) 502 and output activity tokens (mail, package) 602 and can stem event tokens (send, pkg) 504 and output event tokens (send, pkg) 604, which in this case are not changed.

The token mapper 414 can receive tokens (mail, package) 602 and (send, pkg) 604, or, alternatively, tokens (mailed, package) 502 and (send, pkg) 504 and output a score matrix 702. Here, the token mapper can generate a score matrix for pairs of the event tokens and the activity tokens indicating a degree of similarity between the event token and the activity token in each of the pairs. For example, the score matrix can provide a score, score (x,y), for each entry of the score matrix, where each entry corresponds to a different or unique combination of (activity type token, event type token) pairs, as illustrated in FIG. 7. Table 1 below provides one example of a token mapping method in which tokens from the activity label are mapped to tokens from the event type label.

TABLE 1
Token Mapping of Activity Tokens and Event Type Tokens

| | |
|---|---|
| 1. | For each token x in Activity X: |
| 2. | if x is not a natural language term |
| 3. | for each token y in Event Type Y |
| 4. | score(x,y) = (string_edit_dist(x,y)/max(len(x),len(y))) |
| 5. | if x is a natural language term |
| 6. | for each token y in Event Type Y |
| 7. | if y is a natural language token and |
| 8. | x is a synonym/hypernym/holonym of y |
| 9. | score(x,y) = 1 |
| 10. | else |
| 11. | score(x,y) = (string_edit_dist(x,y)/max(len(x),len(y))) |

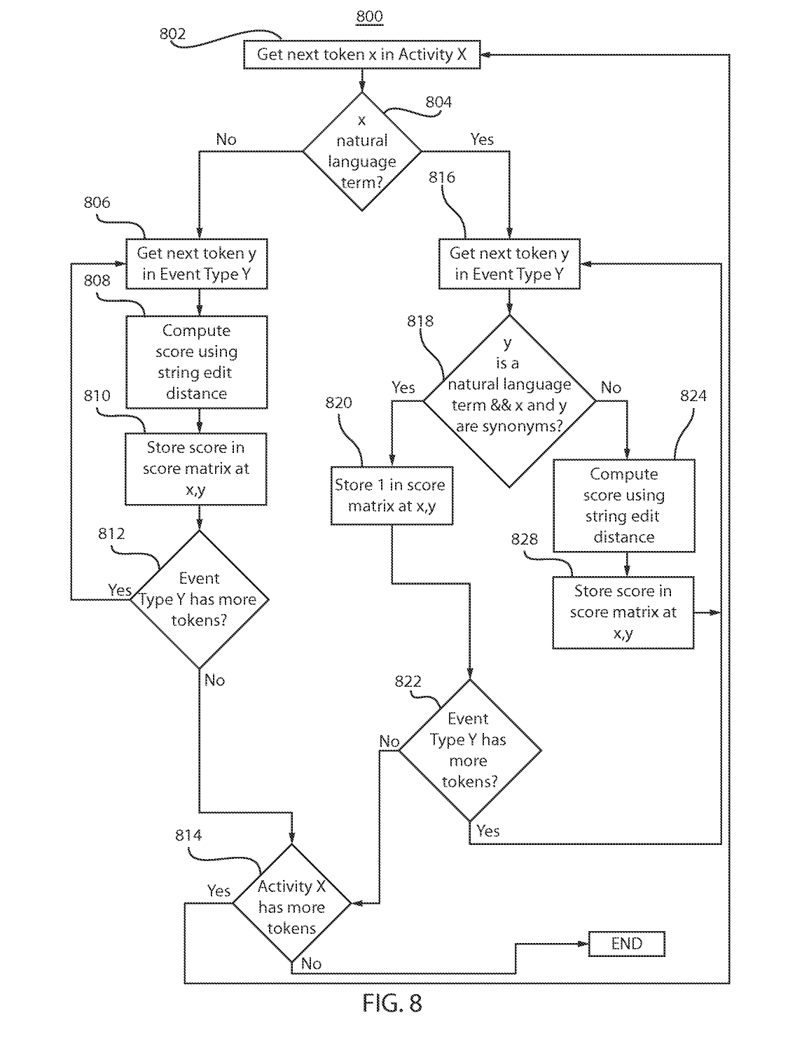

FIG. 8 illustrates a flow diagram of the method described in Table 1. The method 800 of FIG. 8 can begin at step 802, at which the Token Mapper 414 can obtain the next token x in Activity X. At step 804, the Token Mapper 414 can determine whether x is a natural language term. If not, then the method can proceed to step 806, at which the Token Mapper 414 can obtain the next token y in Event Type Y. At step 808, the Token Mapper 414 can compute the score for the pair (x,y) by calculating a string edit distance between Activity token x and Event token y. For example, the score can be computed as follows:

score(x,y)=(string_edit_dist(x,y)/max(len(x),len(y)))

where string_edit_dist(x,y) denotes the string edit distance of activity token, event token pair (x,y), len(x) denotes the length of (i.e., the number of characters in) the Activity token x, len(y) denotes the length of (i.e., the number of characters in) the Event token y, and max(len(x),len(y)) denotes the maximum or largest value between len(x) and len(y). Here, the string edit distance can be calculated as a levenshtein distance, which measures the similarity between two sequences. At step 810, the Token Mapper 414 can store the score, score(x,y), in the score matrix 702 at position x,y. At step 812, the Token Mapper 414 can determine whether the Event Type Y has more tokens. If the Event Type Y includes additional tokens, then the method can proceed to step 806 and can be repeated. Otherwise, the method proceeds to step 814. At step 814, the Token Mapper 414 determines whether Activity X has more tokens. If so, then the method proceeds to step 802 and is repeated. Otherwise, the method can end and the system/method 400 can evaluate another (Activity, Event Type) pair. Returning to step 804, if the Activity token x is a natural langue term, then the method can proceed to step 816, at which the Token Mapper 414 can obtain the next token y in Event Type Y. At step 818, the Token Mapper 414 can determine whether y is a natural language term and x and y are natural language synonyms. If so, then the method can proceed to step 820, at which the Token Mapper 414 assigns a score, score(x,y), of 1 in the score matrix 702 at entry x,y, which is the maximum score that can be assigned in the score matrix 702. Thereafter, the method can proceed to step 822, at which the Token Mapper 414 can determine whether the Event Type Y has more tokens. If the Event Type Y includes additional tokens, then the method can proceed to step 816 and can be repeated. Otherwise, the method proceeds to step 814, which can be performed, as discussed above. If the Token Mapper 414 determines that y is not a natural language term and/or x and y are not natural language synonyms, then the method can proceed to step 824, at which the Token Mapper 414 can compute the score, score (x,y), using a string edit distance, as discussed above with respect to step 808. The method can then proceed to step 828, at which the Token Mapper 414 can store the score, score(x,y), in the score matrix 702 at position x,y. Thereafter, the method can proceed to step 816 and can be repeated.

FIG. 7 illustrates an example of a score matrix 702 computed by the Token Mapper 410 for the Activity tokens (mail, package) 602 and Event Tokens (send, pkg) 604. As illustrated in FIG. 7, the token mapper assigned a score of 1, the maximum score in this example, for the token pair (mail, send) and had assigned a score of 0.428 for the token pair (package, pkg). Here, each score indicates a degree of similarity between the event token and the activity token in the respective token pair.

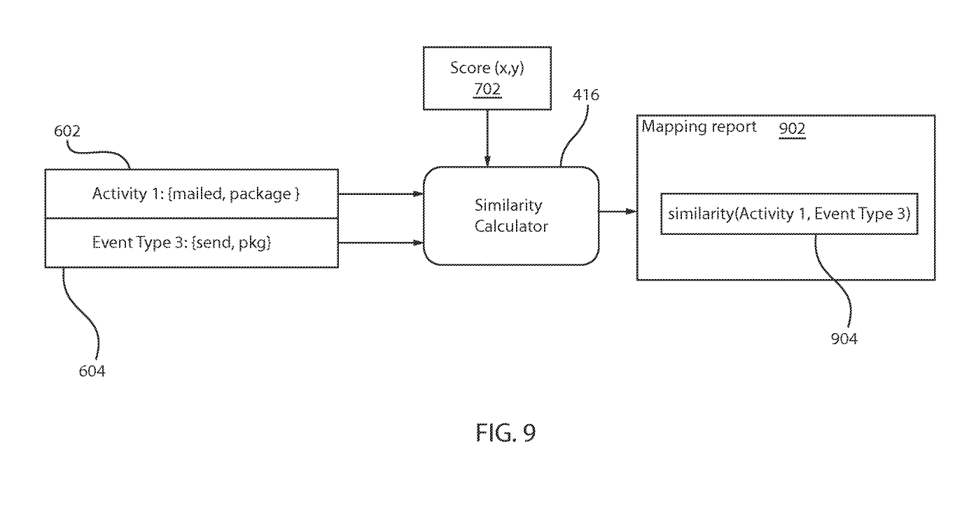

Turning now to the similarity calculator 416, as illustrated in FIG. 9, the similarity calculator 416 can determine whether the event type and the activity are correlated based on the score matrix 702. For example, here, the similarity calculator can receive the tokens (mail, package) 602, tokens (send, pkg) 604 and the score matrix 702 and can output a mapping report 902 including a similarity score 904 for the Activity 1 and the Event Type 3. The suggestion matrix 206 illustrated in FIG. 2 is one example of a mapping report 902. Table 2 below illustrates an example of a method for calculating the similarity of an Activity and an Event Type. The computational method illustrated in Table 2 is based on an index of activity labels based on the similarity scores of the individual words of those labels. If the words are natural language words (i.e. dictionary words), then the comparison is based on whether the words were synonyms, hypernyms, or hyponyms. In turn, if at least one of the words are non-natural language words, then the levenshtein distance is used for scoring. The word scores form the components of the index, which is between 0 and 1 in this example.

TABLE 2
Method and Example for Calculating Similarity Score for Two
Labels

| | |
|---|---|
| 1. | Subtract from 1 the maximum value of each row in the score |
| | matrix and add those values to the accumulator M10 |
| 2. | max_row_score(mail) = 1, max_ row_score(package) = 0.428, |
| | 1 − max_score(mail) = 0, 1 − max_score(package) = 0.572 |
| 3. | M10 = 0.572 |
| 4. | Subtract from 1 the maximum value of each column in the score |
| | matrix and add those values to the accumulator M01 |
| 5. | max_col_score(send) = 1, max_ col_score(pkg) = 0.428, |
| | 1 − max_score(send) =0, 1 − max score(pkg) = 0.572 |
| 6. | M01 = 0.572 |
| 7. | M11 is the sum of scores of Activities X and Event Types Y where |
| | max_row_score(x) = max_col_score(y) = score(x,y) such that x in |
| | X and y in Y. |
| 8. | M11 = score(mail, send) + score(package, pkg) = 1.428 |
| 9. | similarity(Activity 1, Event Type 3) = (M11/(M11 + M10 + M01)) = |
| | .4447 |

Referring again to the score matrix 702, the Similarity Calculator 416 can determine scores of the pairs of event tokens and activity tokens that are ranked highest in the score matrix. For example, the Similarity Calculator 416 can determine first scores denoting a highest ranked pair of the pairs of the event tokens and the activity tokens from each row of the score matrix and second scores denoting a highest ranked pair of the pairs of the event tokens and the activity tokens from each column of the score matrix. For example, in the score matrix 702, the (mail, send) score of 1 is the highest score of the row denoted by “mail” and the (package, pkg) score of 0.428 is the highest score of the row denoted by “package.” Thus, the token pairs (mail, send) and (package, pkg) denote the highest ranked pair of the pairs of the event tokens and the activity tokens from each row of the score matrix. Similarly, the (mail, send) score of 1 is the highest score of the column denoted by “send” and the (package, pkg) score of 0.428 is the highest score of the column denoted by “pkg.” Thus, the token pairs (mail, send) and (package, pkg) denote the highest ranked pair of the pairs of the event tokens and the activity tokens from each column of the score matrix.

In addition, the Similarity Calculator 416 can determine each of the first scores by subtracting a from a maximum score a matrix score in the score matrix of the highest ranked pair from each row of the score matrix, and can determine each of the second scores by subtracting from the maximum score a matrix score in the score matrix of the highest ranked pair from each column of the score matrix. For example, as noted above, the maximum score of the score matrix is 1. As illustrated in lines 1-2 of Table 2, the Similarity Calculator 416 can subtract from 1 the matrix score of (mail, send) and can subtract from 1 the matrix score of (package, pkg) to obtain the first scores of 0 and 0.572. Similarly, as illustrated in lines 1-2 of Table 2, the Similarity Calculator 416 can subtract from 1 the matrix score of (mail, send) and can subtract from 1 the matrix score of (package, pkg) to obtain the second scores of 0 and 0.572. The Similarity Calculator 416 can add the first scores to obtain M10=0.572 and can add the second scores to obtain M01=0.572, as illustrated in lines 1,3 and 4,6 of Table 2. Thereafter, the Similarity Calculator 416 can add the first and second scores M10 and M01, respectively, to obtain M11, as illustrated in lines 7-8 of Table 2. Further, as illustrated in line 9 of Table 2, the Similarity Calculator 416 can compute the similarity score, similarity(Activity 1, Event Type 3), as follows: similarity(Activity 1, Event Type 3)=(M11/(M11+M10+M01))=0.4447.

Thus, after obtaining the similarity score for the Activity 1, Event Type 3 pair, the Similarity Calculator 416 can update the cell or entry of the Activity 1, Event Type 3 pair in the suggestion matrix 206 with the similarity score of 0.4447 if the similarity score is above some user-defined threshold. Accordingly, the Similarity Calculator 416 can indicate in the mapping report 902 that the event type and the activity are correlated in response to determining that the similarity score is above a threshold score. Thresholds here are application-specific. Thus, a reasonable threshold level should be adapted to the particular setting in which the business processes exists. For example, if the nomenclature of the domain is fairly well established, such as, for example, in medicine and patient-care, then the threshold can be set fairly high, i.e. above 0.80. However, if the domain is new and there are many different terms for similar ideas and there exists many initializations, and abbreviations, relatively low thresholds should be set for matching and perhaps a manual inspection of the results should be instituted to ensure that any inconsistent or incorrect matching based on low scores are pruned.

The Similarity Calculator 416 can calculate the similarity score and can populate/update the suggestion matrix 206 for other Activity and Event Type pairs in the same manner. Thereafter, the Similarity Calculator 416 can output the suggestion matrix 206 at block 418 in FIG. 4 through the user interface 126 of FIG. 1. Optionally, the Similarity Calculator 416 can, at block 422 of FIG. 4, update the predefined mapping store 406 with the similarity score for the Event Type 3 and the Activity 1 pair, and also for any other Event Type, Activity pair, if the user accepts the suggestion.

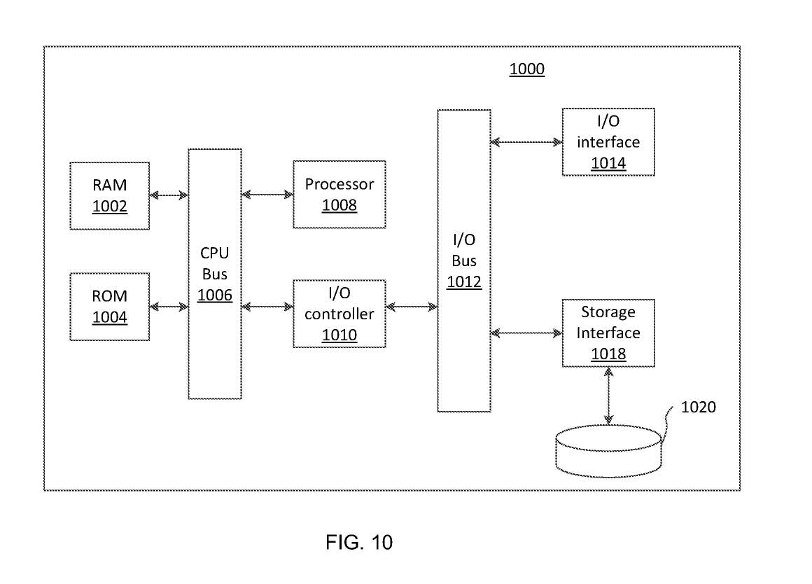

Referring now to FIG. 10, an exemplary computing system 1000 in which system embodiments of the present principles described above can be implemented, and by which method embodiments of the present principles described above can be implemented, is illustrated. The computing system 1000 includes a hardware processor 1008 that can access random access memory 1002 and read only memory 1004 through a central processing unit bus 1006. In addition, the processor 1008 can also access a storage medium 1020 through an input/output controller 1010, an input/output bus 1012 and a storage interface 1018, as illustrated in FIG. 1000. The system 1000 can also include an input/output interface 1014, which can be coupled to a display device, keyboard, mouse, touch screen, external drives or storage mediums, etc., for the input and output of data to and from the system 1000. In accordance with one exemplary embodiment, the processor 1008 can access software instructions stored in the storage medium 1020 and can access memories 1002 and 1004 to run the software and thereby implement the method 1000 described above. In addition, the hardware processor 1008 can, for example by executing software instructions stored on the storage medium 1020, implement system elements described above, such as the mapping checker 408, the tokenizer 410, the token stemmer 412, the token mapper 414 and the similarity calculator 416. Alternatively, each of these system elements can be implemented via a plurality of respective processors 1008. Further, the process models 104, the event types 118 and the external knowledge 128 can be stored in the storage medium 1020. Additionally, the input/output interface 1014 can implement the user interface 126 and/or can be employed to output a suggestion matrix 420. Alternatively or additionally, the suggestion matrix 420 can be stored in the storage medium 1020 for subsequent retrieval by a user.

Having described preferred embodiments of a system and method for business process event mapping (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for mapping an event type to an activity in a business process model comprising:
tokenizing the event type and the activity by determining event tokens for event type labels in the event type and determining activity tokens for activity labels in the activity;
generating a score matrix for pairs of the event tokens and the activity tokens indicating a degree of similarity between the event token and the activity token in each of the pairs;
determining, by at least one hardware processor, whether the event type and the activity are correlated by determining scores of the pairs of event tokens and activity tokens that are ranked highest in said score matrix; and
outputting a mapping report indicating whether the event type and the activity are correlated in the business process model.

2. The method of claim 1, wherein the generating the score matrix further comprises at least one of assessing whether any of the event tokens and the activity tokens are natural language synonyms or determining a string edit distance between the event token and the activity token in each pair of at least a subset of the pairs.

3. The method of claim 2, wherein the generating the score matrix further comprises assigning maximum scores in the score matrix to any pairs of the event tokens and activity tokens that include natural language synonyms.

4. The method of claim 1, wherein the scores comprise first scores denoting a highest ranked pair of the pairs of the event tokens and the activity tokens from each row of the score matrix and second scores denoting a highest ranked pair of the pairs of the event tokens and the activity tokens from each column of the score matrix.

5. The method of claim 4, wherein the determining whether the event type and the activity are correlated further comprises determining each of the first scores by subtracting from a maximum score a matrix score in the score matrix of the highest ranked pair from each row of the score matrix, and wherein the determining whether the event type and the activity are correlated further comprises determining each of the second scores by subtracting from the maximum score a matrix score in the score matrix of the highest ranked pair from each column of the score matrix.

6. The method of claim 4, wherein the determining whether the event type and the activity are correlated further comprises adding the first scores to obtain a first score sum and adding the second scores to obtain a second score sum.

7. The method of claim 6, wherein the determining whether the event type and the activity are correlated further comprises adding the first score sum and the second score sum to obtain a similarity score for the event type and the activity.

8. The method of claim 7, wherein the determining whether the event type and the activity are correlated further comprises indicating in the mapping report that the event type and the activity are correlated in response to determining that the similarity score is above a threshold score.

9. The method of claim 8, further comprising updating a predefined mapping store with said similarity score for the event type and the activity.

10. The method of claim 1, wherein the event type and the activity are included in a plurality of event types and activities for the business process model and wherein the mapping report is a suggestion matrix denoting whether different pairs of event types and activities of said plurality of event types and activities are correlated.

11. A computer readable storage medium comprising a computer readable program for mapping an event type to an activity in a business process model, wherein the computer readable program when executed on a computer causes the computer to perform the steps of:
tokenizing the event type and the activity by determining event tokens for event type labels in the event type and determining activity tokens for activity labels in the activity;
generating a score matrix for pairs of the event tokens and the activity tokens indicating a degree of similarity between the event token and the activity token in each of the pairs;
determining whether the event type and the activity are correlated by determining scores of the pairs of event tokens and activity tokens that are ranked highest in said score matrix; and
outputting a mapping report indicating whether the event type and the activity are correlated in the business process model.

12. A system for mapping an event type to an activity in a business process model comprising:
a tokenizer configured to tokenize the event type and the activity by determining event tokens for event type labels in the event type and determining activity tokens for activity labels in the activity;
a token mapper configured to generate a score matrix for pairs of the event tokens and the activity tokens indicating a degree of similarity between the event token and the activity token in each of the pairs and configured to perform at least one of an assessment of whether any of the event tokens and the activity tokens are natural language synonyms or a determination of a string edit distance between the event token and the activity token in each pair of at least a subset of the pairs; and
a similarity calculator, implemented by at least one hardware processor, configured to determine whether the event type and the activity are correlated by determining scores of the pairs of event tokens and activity tokens that are ranked highest in said score matrix and to output a mapping report indicating whether the event type and the activity are correlated in the business process model.

13. The system of claim 12, wherein the token mapper is further configured to assign maximum scores in the score matrix to any pairs of the event tokens and activity tokens that include natural language synonyms.

14. The system of claim 12, wherein the scores comprise first scores denoting a highest ranked pair of the pairs of the event tokens and the activity tokens from each row of the score matrix and second scores denoting a highest ranked pair of the pairs of the event tokens and the activity tokens from each column of the score matrix.

15. The system of claim 14, wherein the similarity calculator is further configured to determine each of the first scores by subtracting from a maximum score a matrix score in the score matrix of the highest ranked pair from each row of the score matrix, and wherein the similarity calculator is further configured to determine each of the second scores by subtracting from the maximum score a matrix score in the score matrix of the highest ranked pair from each column of the score matrix.

16. The system of claim 14, wherein the similarity calculator is further configured to add the first scores to obtain a first score sum and add the second scores to obtain a second score sum.

17. The system of claim 16, wherein the similarity calculator is further configured to add the first score sum and the second score sum to obtain a similarity score for the event type and the activity.

18. The system of claim 17, wherein the similarity calculator is further configured to indicate in the mapping report that the event type and the activity are correlated in response to determining that the similarity score is above a threshold score.

19. The system of claim 18, wherein the similarity calculator is further configured to update a predefined mapping store with said similarity score for the event type and the activity.

20. The system of claim 12, wherein the event type and the activity are included in a plurality of event types and activities for the business process model and wherein the mapping report is a suggestion matrix denoting whether different pairs of event types and activities of said plurality of event types and activities are correlated.
